(19) United States
(12) Patent Application Publication
(10) Pub. No.: US 2012/0188437 A1
(43) Pub. Date: Jul. 26, 2012

(54) ELECTRONIC CAMERA

(75) Inventor: Masayoshi Okamoto, Daito-shi (JP)

(73) Assignee: SANYO ELECTRIC CO., LTD., Osaka (JP)

(21) Appl. No.: 13/314,321

(22) Filed: Dec. 8, 2011

(30) Foreign Application Priority Data
Jan. 25, 2011 (JP) 2011-012514

(51) Int. Cl. H04N 5/232

(52) U.S. Cl. 348/349; 348/E05.042

(57) ABSTRACT

An electronic camera includes an imager. An imager has an imaging surface capturing an optical image through a focus lens and repeatedly outputs an electronic image corresponding to the optical image. A designator designates, on the imaging surface, an area corresponding to a partial image coincident with a dictionary image out of the electronic image outputted from the imager. A changer repeatedly changes a distance from the focus lens to the imaging surface after a designating process of the designator. A calculator calculates a matching degree between a partial image outputted from the imager corresponding to the area designated by the designator and the dictionary image, corresponding to each of a plurality of distances defined by the changer. An adjuster adjusts the distance from the focus lens to the imaging surface based on a calculated result of the calculator.

### CROSS REFERENCE OF RELATED APPLICATION

The disclosure of Japanese Patent Application No. 2011-12514, which was filed on Jan. 25, 2011, is incorporated here by reference.

### BACKGROUND OF THE INVENTION

1. Field of the Invention

The present invention relates to an electronic camera. More particularly, the present invention relates to an electronic camera which sets a distance from a focus lens to an imaging surface to a distance corresponding to a focal point.

2. Description of the Related Art

According to one example of this type of camera, in a display screen where an animal which is an object and a cage which is an obstacle are displayed, a focal point is set by an operator moving a focus setting mark to a part of a display region of an animal to be focused. Moreover, a non-focal point is set by the operator moving a non-focal point setting mark to a part of a display region of a cage undesired to be focused. After an imaging lens is moved, a shooting is performed so as to come into focus on thus set focal point.

However, in the above-described camera, an operation of the operator is needed to set the focal point, and therefore, a focus performance may be decreased if the operation of the operator is unskilled.

### SUMMARY OF THE INVENTION

An electronic camera according to the present invention, comprises: an imager, having an imaging surface capturing an optical image through a focus lens, which repeatedly outputs an electronic image corresponding to the optical image; a designator which designates, on the imaging surface, an area corresponding to a partial image coincident with a dictionary image out of the electronic image outputted from the imager; a changer which repeatedly changes a distance from the focus lens to the imaging surface after a designating process of the designator; a calculator which calculates a matching degree between a partial image outputted from the imager corresponding to the area designated by the designator and the dictionary image, corresponding to each of a plurality of distances defined by the changer; and an adjuster which adjusts the distance from the focus lens to the imaging surface based on a calculated result of the calculator.

According to the present invention, a computer program embodied in a tangible medium, which is executed by a processor of an electronic camera, the program comprises: an imaging step, having an imaging surface capturing an optical image through a focus lens, of repeatedly outputting an electronic image corresponding to the optical image; a designating step of designating, on the imaging surface, an area corresponding to a partial image coincident with a dictionary image out of the electronic image outputted from the imaging step; a changing step of repeatedly changing a distance from the focus lens to the imaging surface after a designating process of the designating step; a calculating step of calculating a matching degree between a partial image outputted from the imaging step corresponding to the area designated by the designating step and the dictionary image, corresponding to each of a plurality of distances defined by the changing step; and an adjusting step of adjusting the distance from the focus lens to the imaging surface based on a calculated result of the calculating step.

According to the present invention, an imaging control method executed by an electronic camera, comprises: an imaging step, having an imaging surface capturing an optical image through a focus lens, of repeatedly outputting an electronic image corresponding to the optical image; a designating step of designating, on the imaging surface, an area corresponding to a partial image coincident with a dictionary image out of the electronic image outputted from the imaging step; a changing step of repeatedly changing a distance from the focus lens to the imaging surface after a designating process of the designating step; a calculating step of calculating a matching degree between a partial image outputted from the imaging step corresponding to the area designated by the designating step and the dictionary image, corresponding to each of a plurality of distances defined by the changing step; and an adjusting step of adjusting the distance from the focus lens to the imaging surface based on a calculated result of the calculating step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of an allocation state of an evaluation area in an imaging surface;

FIG. 4 is an illustrative view showing one example of a face-detection frame structure used for a face detecting process;

FIG. 5 is an illustrative view showing one example of a configuration of a face dictionary referred to in the embodiment in FIG. 2;

FIG. 6 is an illustrative view showing one portion of the face detecting process and a human-body detecting process in a person detecting task;

FIG. 7 is an illustrative view showing one example of a configuration of a register referred to in the face detecting process;

FIG. 8 is an illustrative view showing one example of an image representing a face of a person captured in the face detecting process;

FIG. 9 is an illustrative view showing another example of the image representing the face of the person captured in the face detecting process;

FIG. 10 is an illustrative view showing one example of a human-body detection frame structure used in a human-body detecting process;

FIG. 11 is an illustrative view showing one example of a configuration of a human-body dictionary referred to in the embodiment in FIG. 2;

FIG. 12 is an illustrative view showing one example of a configuration of a register referred to in the human-body detecting process;

FIG. 13 is an illustrative view showing one example of an image representing a human-body captured in the human-body detecting process;

FIG. 14 is an illustrative view showing another example of the image representing the human-body captured in the human-body detecting process;

FIG. 15 is an illustrative view showing one portion of the embodiment in FIG. 2;

FIG. 16 is an illustrative view showing another portion of the embodiment in FIG. 2;

FIG. 17 is an illustrative view showing still another portion of the embodiment in FIG. 2;

FIG. 18 is an illustrative view showing yet another portion of the embodiment in FIG. 2;

FIG. 19 is an illustrative view showing one example of a register applied to the embodiment in FIG. 2;

FIG. 20 is an illustrative view showing one example of a person frame structure displayed on a monitor screen;

FIG. 21 is an illustrative view showing one example of a configuration of a register referred to in a person-priority AF process;

FIG. 22 is an illustrative view showing one example of behavior detecting a focal point;

FIG. 23 is a flowchart showing one portion of behavior of a CPU applied to the embodiment in FIG. 2;

FIG. 24 is a flowchart showing another portion of behavior of the CPU applied to the embodiment in FIG. 2;

FIG. 25 is a flowchart showing still another portion of behavior of the CPU applied to the embodiment in FIG. 2;

FIG. 26 is a flowchart showing yet another portion of behavior of the CPU applied to the embodiment in FIG. 2;

FIG. 27 is a flowchart showing another portion of behavior of the CPU applied to the embodiment in FIG. 2;

FIG. 28 is a flowchart showing still another portion of behavior of the CPU applied to the embodiment in FIG. 2;

FIG. 29 is a flowchart showing yet another portion of behavior of the CPU applied to the embodiment in FIG. 2;

FIG. 30 is a flowchart showing another portion of behavior of the CPU applied to the embodiment in FIG. 2;

FIG. 31 is a flowchart showing still another portion of behavior of the CPU applied to the embodiment in FIG. 2;

FIG. 32 is a flowchart showing yet another portion of behavior of the CPU applied to the embodiment in FIG. 2;

FIG. 33 is a flowchart showing one portion of behavior of the CPU applied to another embodiment of the present invention;

FIG. 34 is an illustrative view showing one example of a configuration of a register applied to the embodiment in FIG. 33;

FIG. 35 is an illustrative view showing one portion of the embodiment in FIG. 33; and

FIG. 36 is a block diagram showing a configuration of another embodiment of the present invention.

### DETAILED DESCRIPTION OF THE PREFERRED EMBODIMENTS

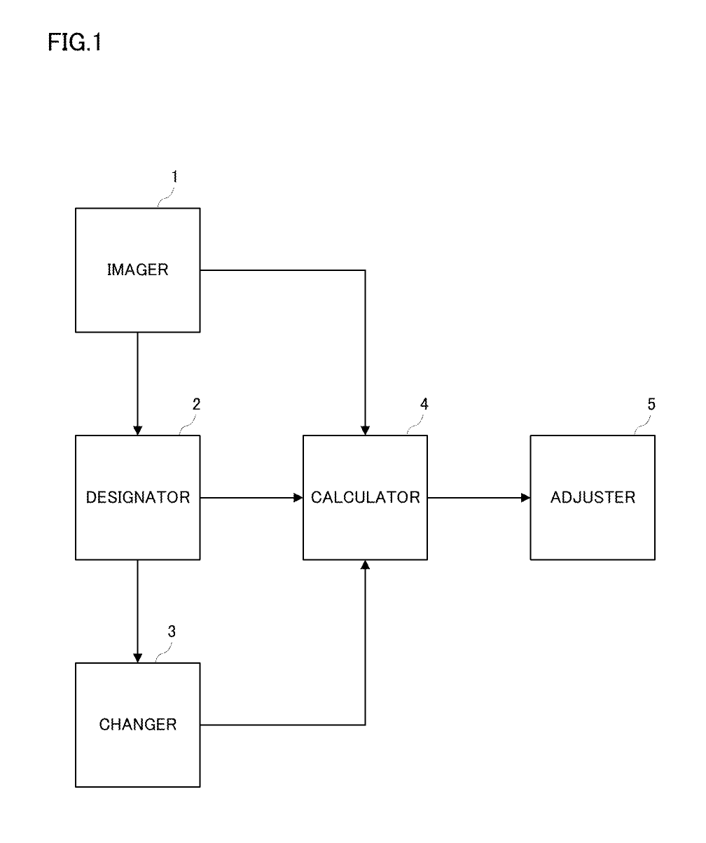

With reference to FIG. 1, an electronic camera according to one embodiment of the present invention is basically configured as follows: An imager 1 has an imaging surface capturing an optical image through a focus lens and repeatedly outputs an electronic image corresponding to the optical image. A designator 2 designates, on the imaging surface, an area corresponding to a partial image coincident with a dictionary image out of the electronic image outputted from the imager 1. A changer 3 repeatedly changes a distance from the focus lens to the imaging surface after a designating process of the designator 2. A calculator 4 calculates a matching degree between a partial image outputted from the imager 1 corresponding to the area designated by the designator 2 and the dictionary image, corresponding to each of a plurality of distances defined by the changer 3. An adjuster 5 adjusts the distance from the focus lens to the imaging surface based on a calculated result of the calculator 4.

The distance from the focus lens to the imaging surface is repeatedly changed after the area corresponding to the partial image coincident with the dictionary image is designated on the imaging surface. The matching degree between the partial image corresponding to the designated area and the dictionary image is calculated corresponding to each of the plurality of distances defined by the changing process. The calculated matching degree is regarded as a focus degree corresponding to an object equivalent to the partial image, and the distance from the focus lens to the imaging surface is adjusted based on the matching degree. Thereby, a focus performance is improved.

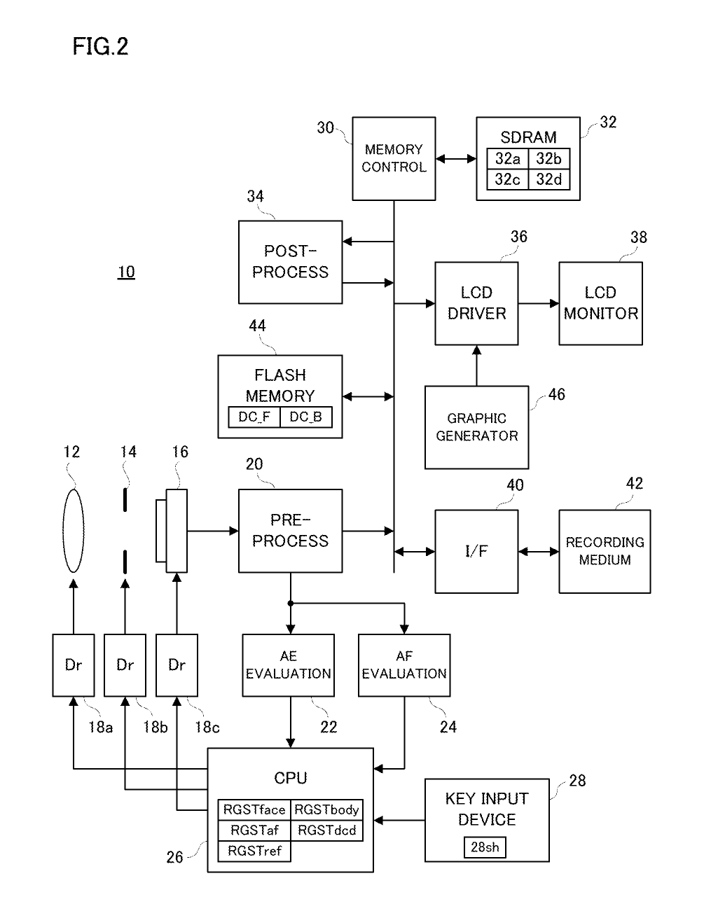

With reference to FIG. 2, a digital camera 10 according to one embodiment includes a focus lens 12 and an aperture unit 14 driven by drivers 18a and 18b, respectively. An optical image of a scene that underwent these components enters, with irradiation, an imaging surface of an image sensor 16, and is subjected to a photoelectric conversion. Thereby, electric charges representing a scene image are produced.

When a power source is applied, in order to execute a moving-image taking process, a CPU 26 commands a driver 18c to repeat an exposure procedure and an electric-charge reading-out procedure under an imaging task. In response to a vertical synchronization signal Vsync periodically generated from an SG (Signal Generator) not shown, the driver 18c exposes the imaging surface and reads out the electric charges produced on the imaging surface in a raster scanning manner. From the image sensor 16, raw image data that is based on the read-out electric charges is cyclically outputted.

A pre-processing circuit 20 performs processes, such as digital clamp, pixel defect correction, gain control and etc., on the raw image data outputted from the image sensor 16. The raw image data on which these processes are performed is written into a raw image area 32a of an SDRAM 32 through a memory control circuit 30.

A post-processing circuit 34 reads out the raw image data accommodated in the raw image area 32a through the memory control circuit 30, and performs a color separation process, a white balance adjusting process and a YUV converting process, on the read-out raw image data. Furthermore, the post-processing circuit 34 executes a zoom process for display and a zoom process for search to image data that comply with a YUV format, in a parallel manner. As a result, display image data and search image data that comply with the YUV format is individually created. The display image data is written into a display image area 32b of the SDRAM 32 by the memory control circuit 30. The search image data is written into a search image area 32c of the SDRAM 32 by the memory control circuit 30.

An LCD driver 36 repeatedly reads out the display image data accommodated in the display image area 32b through the memory control circuit 30, and drives an LCD monitor 38 based on the read-out image data. As a result, a real-time moving image (a live view image) of the scene is displayed on a monitor screen.

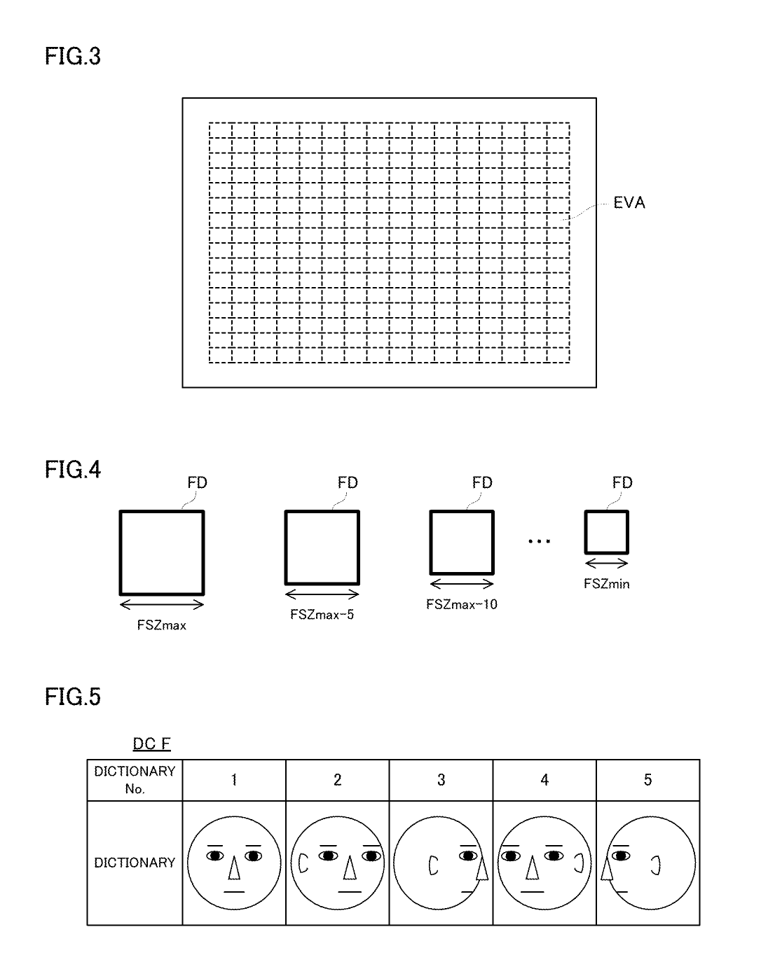

With reference to FIG. 3, an evaluation area EVA is allocated to a center of the imaging surface. The evaluation area EVA is divided into 16 portions in each of a horizontal direction and a vertical direction; therefore, 256 divided areas form the evaluation area EVA. Moreover, in addition to the above-described processes, the pre-processing circuit 20 shown in FIG. 2 executes a simple RGB converting process which simply converts the raw image data into RGB data.

An AE evaluating circuit 22 integrates RGB data belonging to the evaluation area EVA, out of the RGB data produced by the pre-processing circuit 20, at every time the vertical synchronization signal Vsync is generated. Thereby, 256 integral values (256 AE evaluation values) are outputted from the AE evaluating circuit 22 in response to the vertical synchronization signal Vsync. An AF evaluating circuit 24 integrates a high-frequency component of the RGB data belonging to the evaluation area EVA, out of the RGB data generated by the pre-processing circuit 20, at every time the vertical synchronization signal Vsync is generated. Thereby, 256 integral values (256 AF evaluation values) are outputted from the AF evaluating circuit 24 in response to the vertical synchronization signal Vsync. Processes based on thus obtained AE evaluation values and the AF evaluation values will be described later.

Under a person detecting task executed in parallel with the imaging task, the CPU 26 set a flag FLG_f to “0” as an initial setting. Subsequently, the CPU 26 executes a face detecting process in order to search for a face image of a person from the search image data accommodated in the search image area 32c, at every time the vertical synchronization signal Vsync is generated.

In the face detecting process, a face-detection frame structure FD of which a size is adjusted as shown in FIG. 4 and a face dictionary DC_F containing five dictionary images (=face images of which directions are mutually different) shown in FIG. 5 are used. It is noted that the face dictionary DC_F is stored in a flash memory 44.

In the face detecting process, the whole evaluation area EVA is set as a face portion search area, firstly. Moreover, in order to define a variable range of the size of the face-detection frame structure FD, a maximum size FSZmax is set to “200”, and a minimum size FSZmin is set to “20”.

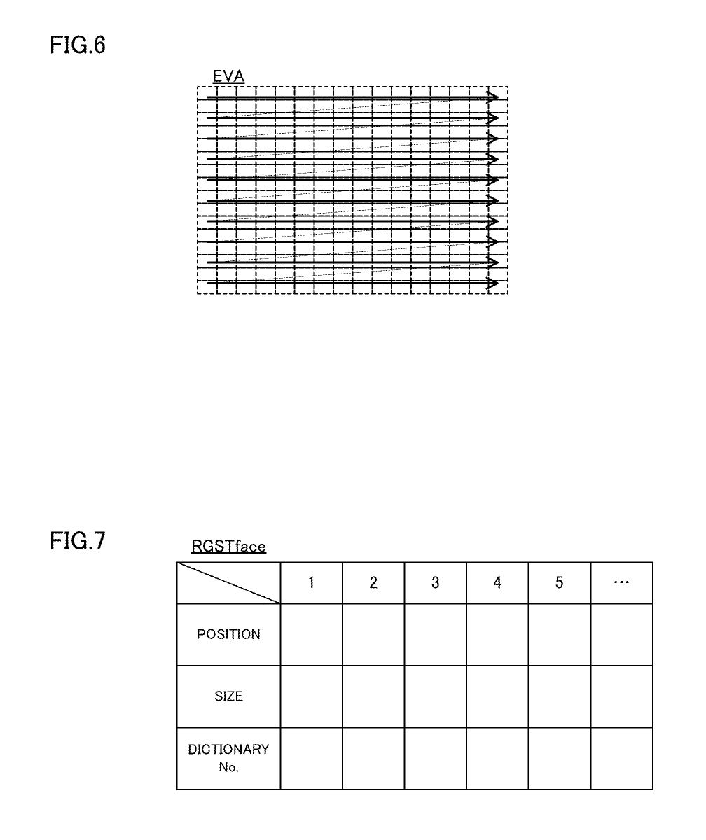

The face-detection frame structure FD is moved by each predetermined amount in the raster scanning manner, from a start position (an upper left position) toward an ending position (a lower right position) of the face portion search area (see FIG. 6). Moreover, the size of the face-detection frame structure FD is reduced by a scale of “5” from “FSZmax” to “FSZmin” at every time the face-detection frame structure FD reaches the ending position.

Partial search image data belonging to the face-detection frame structure FD is read out from the search image area 32c through the memory control circuit 30. A characteristic amount of the read-out search image data is compared with a characteristic amount of each of the five dictionary images contained in the face dictionary DC_F. When a matching degree equal to or more than a threshold value TH_F is obtained, it is regarded that the face image has been detected. A position and a size of the face-detection frame structure FD and a dictionary number of a comparing resource at a current time point are registered as face information in a face-detection register RGSTface shown in FIG. 7.

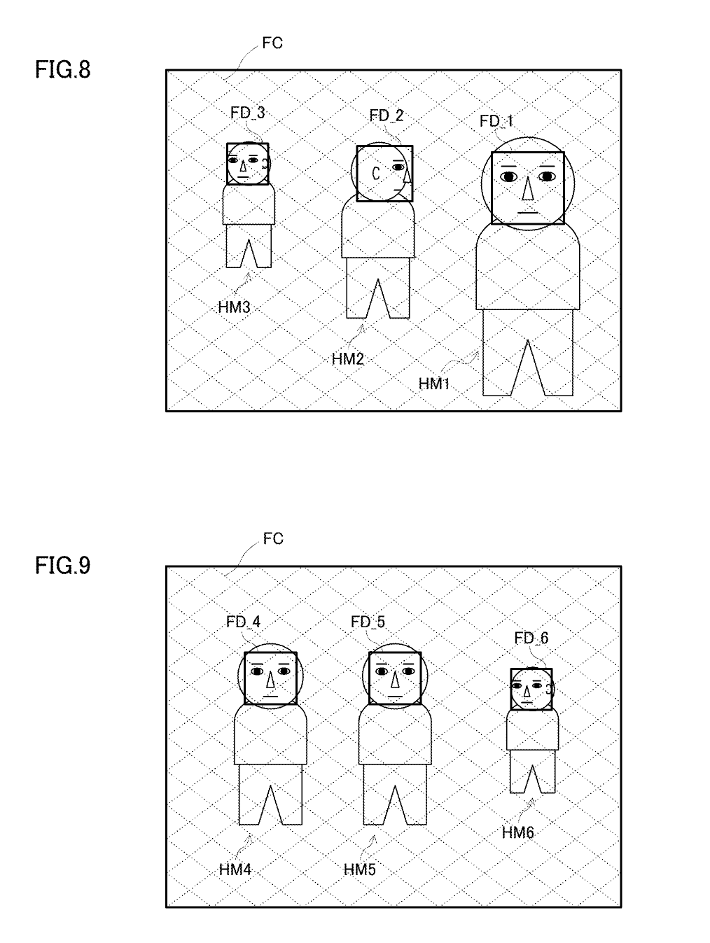

Thus, when persons HM1, HM2 and HM3 are captured by the imaging surface as shown in FIG. 8, the face information registered in the face-detection register RGSTface indicates a position and a size of each of three face-detection frame structures FD_1, FD_2 and FD_3 shown in FIG. 8. It is noted that, according to an example shown in FIG. 8, there is a fence FC constructed by grid-like wire meshes at a near side from the persons HM1, HM2 and HM3.

Moreover, when persons HM4, HM5 and HM6 are captured by the imaging surface as shown in FIG. 9, the face information registered in the face-detection register RGSTface indicates a position and a size of each of three face-detection frame structures FD_4, FD_5 and FD_6 shown in FIG. 9. It is noted that, according to an example shown in FIG. 9, there is the fence FC constructed by the grid-like wire meshes at a near side from the persons HM4, HM5 and HM6.

After the face detecting process is completed, when there is no registration of the face information in the face-detection register RGSTface, i.e., when a face of a person has not been discovered, the CPU 26 executes a human-body detecting process in order to search for a human-body image from the search image data accommodated in the search image area 32c.

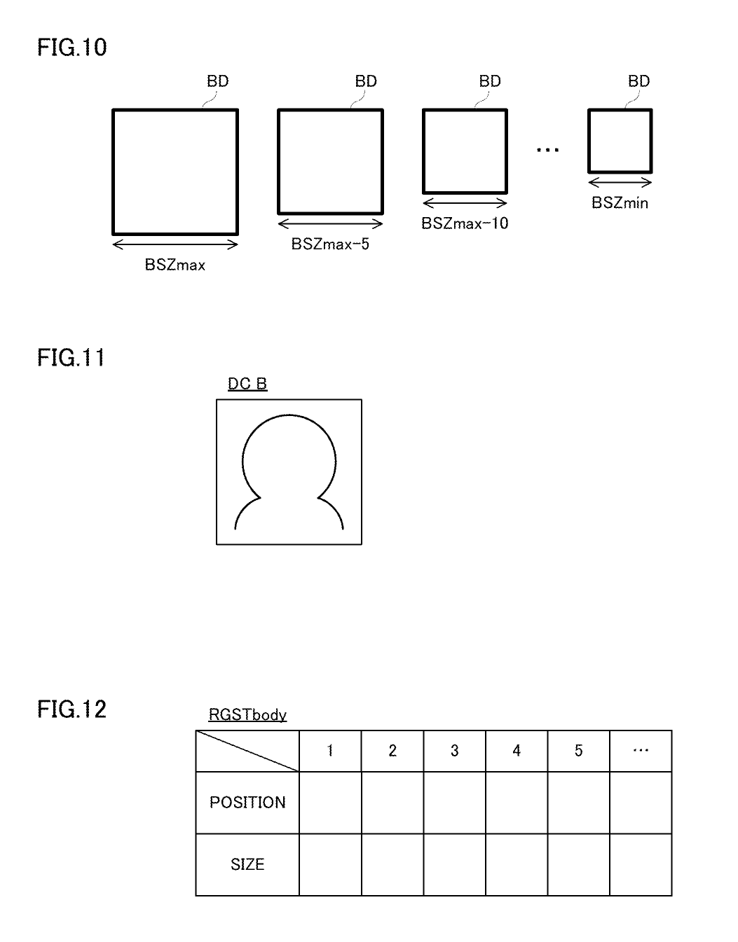

In the human-body detecting process, a human-body-detection frame structure BD of which size is adjusted as shown in FIG. 10 and a human-body dictionary DC_B containing a simple dictionary image (=an outline image of an upper body) shown in FIG. 11 are used. It is noted that the human-body dictionary DC_B is stored in the flash memory 44.

In the human-body detecting process, the whole evaluation area EVA is set as a human-body search area, firstly. Moreover, in order to define a variable range of the size of the human-body-detection frame structure BD, a maximum size BSZmax is set to “200”, and a minimum size BSZmin is set to “20”.

The human-body-detection frame structure BD is also moved by each predetermined amount in the raster scanning manner, from a start position (an upper left position) toward an ending position (a lower right position) of the human-body search area (see FIG. 6). Moreover, the size of the human-body-detection frame structure BD is reduced by a scale of “5” from “BSZmax” to “BSZmin” at every time the human-body-detection frame structure BD reaches the ending position.

Partial search image data belonging to the human-body-detection frame structure BD is read out from the search image area 32c through the memory control circuit 30. A characteristic amount of the read-out search image data is compared with a characteristic amount of the dictionary image contained in the human-body dictionary DC_B. When a matching degree equal to or more than a threshold value TH_B is obtained, it is regarded that the human-body image is detected. A position and a size of the human-body-detection frame structure BD at a current time point are registered as human-body information in a human-body-detection register RGSTbody shown in FIG. 12.

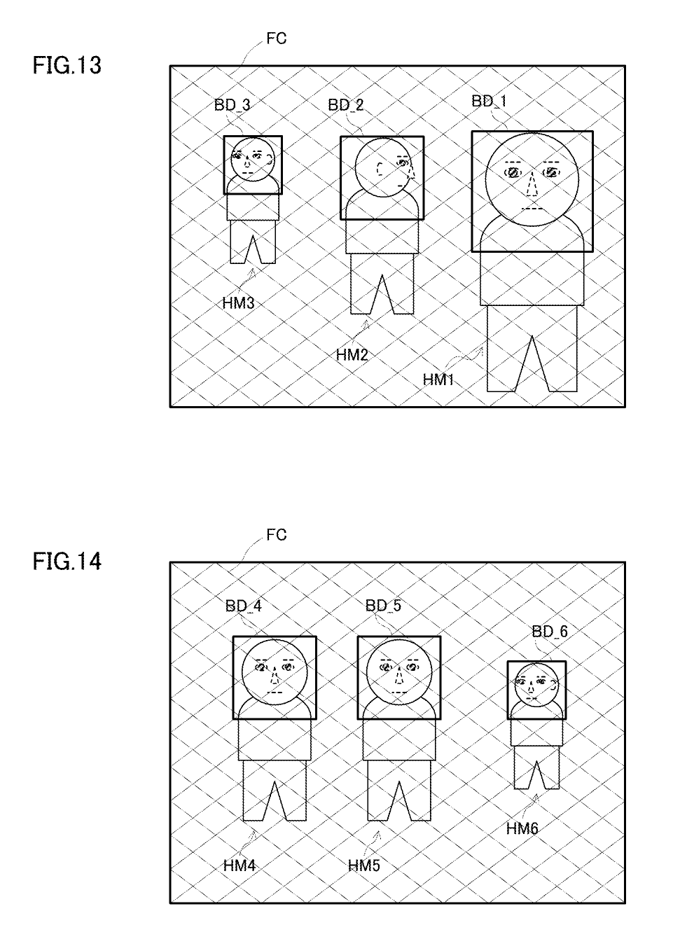

Thus, when the persons HM1, HM2 and HM3 are captured by the imaging surface as shown in FIG. 13, the human-body information registered in the human-body-detection register RGSTbody indicates a position and a size of each of three human-body-detection frame structures BD_1, BD_2 and BD_3 shown in FIG. 13. It is noted that, according to an example shown in FIG. 13, there is the fence FC constructed by the grid-like wire meshes at a near side from the persons HM1, HM2 and HM3.

Moreover, when the persons HM4, HM5 and HM6 are captured by the imaging surface as shown in FIG. 14, the face information registered in the human-body-detection register RGSTbody indicates a position and a size of each of three human-body-detection frame structures BD_4, BD_5 and BD_6 shown in FIG. 14. It is noted that, according to an example shown in FIG. 14, there is the fence FC constructed by the grid-like wire meshes at a near side from the persons HM4, HM5 and HM6.

After the face detecting process is completed, when the face information has been registered in the face-detection register RGSTface, the CPU 26 uses a region indicated by face information in which a size is the largest, out of the face information registered in the face-detection register RGSTface, as a target region of an AF process described later. When a plurality of the face information in which the size is the largest is registered, out of a plurality of maximum size of face information, a region indicated by face information in which a position is the nearest to the center of the imaging surface is used as a target region of the AF process.

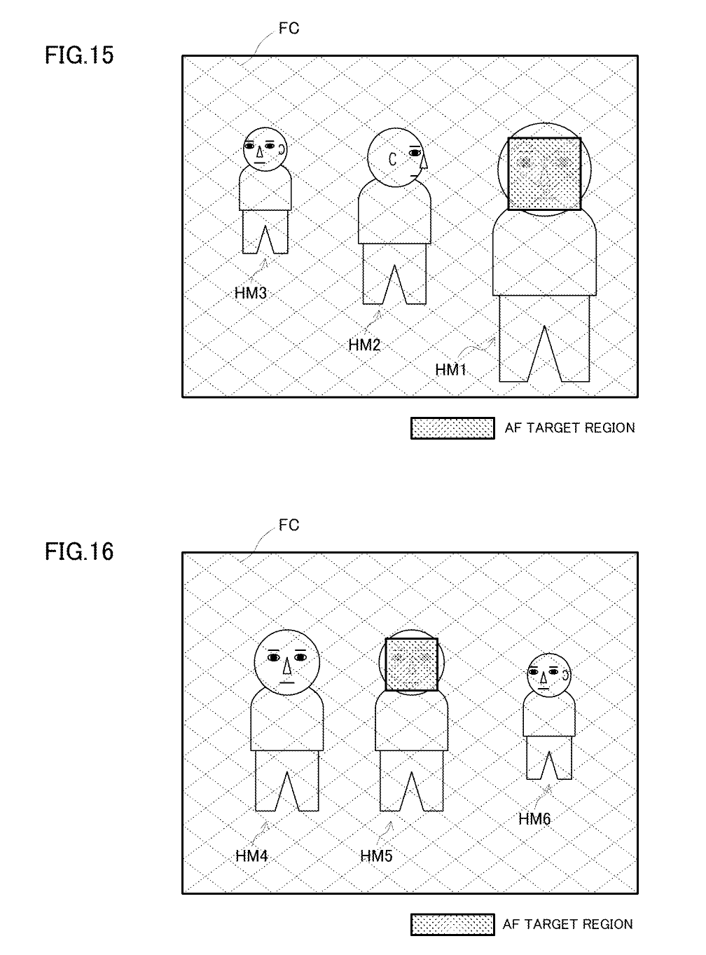

When the persons HM1, HM2 and HM3 are captured by the imaging surface as shown in FIG. 8, a size of the face-detection frame structure FD_1 surrounding a face of the person HM1 is the largest. Thus, a region shown in FIG. 15 is used as a target region of the AF process.

When the persons HM4, HM5 and HM6 are captured by the imaging surface as shown in FIG. 9, face information in which a size is the largest is the face-detection frame structure FD_4 surrounding a face of the person HM4 and the face-detection frame structure FD_5 surrounding a face of the person HM5. Moreover, the face-detection frame structure FD_5 is nearer to the center than the face-detection frame structure FD_4. Thus, a region shown in FIG. 16 is used as a target region of the AF process.

After the human-body detecting process is executed and completed, when the human-body information is registered in the human-body-detection-register RGSTbody, the CPU 26 uses human-body information in which a size is the largest, out of the human-body information registered in the human-body-detection-register RGSTbody, as a target region of the AF process. When a plurality of human-body information in which a size is the largest is registered, out of a plurality of maximum size of human-body information, a region indicated by human-body information in which a position is the nearest to the center of the imaging surface is used as a target region of the AF process described later.

When the persons HM1, HM2 and HM3 are captured by the imaging surface as shown in FIG. 13, a size of the human-body-detection frame structure BD_1 surrounding a body of the person HM1 is the largest. Thus, a region shown in FIG. 17 is used as a target region of the AF process.

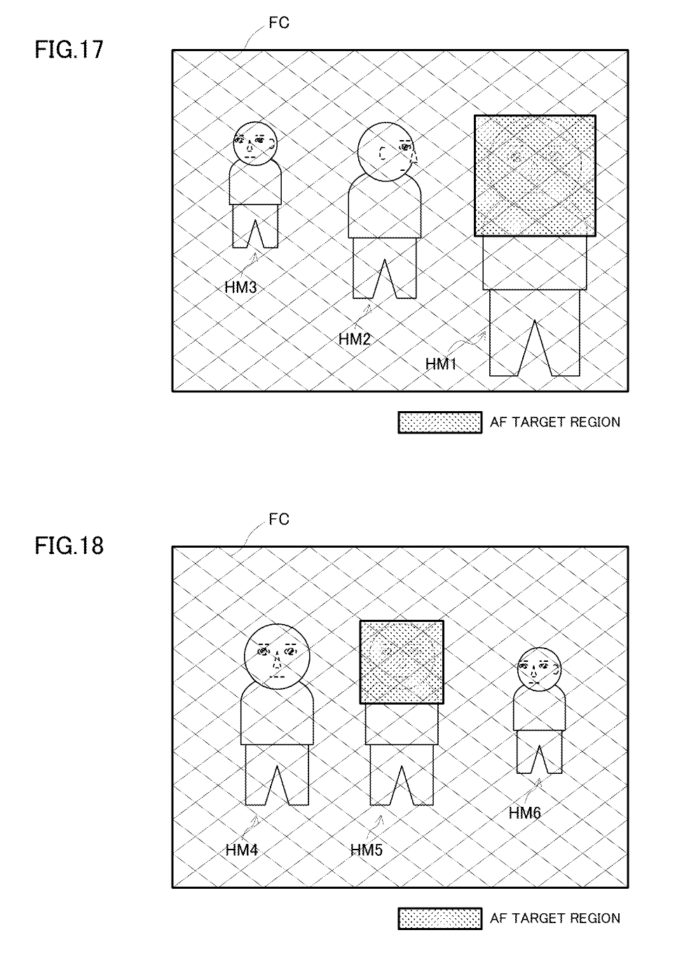

Moreover, when the persons HM4, HM5 and HM6 are captured by the imaging surface as shown in FIG. 14, human-body information in which a size is the largest is the human-body-detection frame structure BD_4 surrounding a body of the person HM4 and the human-body-detection frame structure BD_5 surrounding a body of the person HM5. Moreover, the human-body-detection frame structure BD_5 is nearer to the center than the human-body-detection frame structure BD_4. Thus, a region shown in FIG. 18 is used as a target region of the AF process.

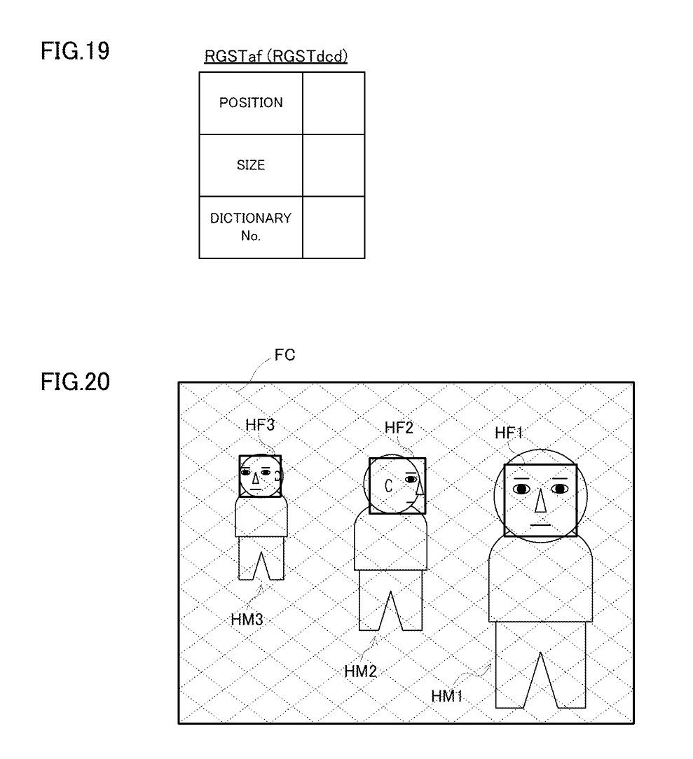

A position and a size of the face information or the human-body information used as the target region of the AF process and a dictionary number of a comparing resource are registered in an AF target register RGSTaf shown in FIG. 19. It is noted that, when the human-body information is registered, “0” is described as the dictionary number. Moreover, in order to declare that a person has been discovered, the CPU 26 sets the flag FLG_f to “1”.

It is noted that, after the human-body detecting process is completed, when there is no registration of the human-body information in the human-body-detection register RGSTbody, i.e., when any of a face and a human-body has not been discovered, the CPU 26 sets the flag FLG_f to “0” in order to declare that the person is undiscovered.

When a shutter button 28sh is in a non-operated state, the CPU 26 executes following processes. When the flag FLG_f indicates “0”, the CPU 26 executes a simple AE process that is based on output from the AE evaluating circuit 22 under the imaging task so as to calculate an appropriate EV value. The simple AE process is executed in parallel with the moving-image taking process, and an aperture amount and an exposure time period that define the calculated appropriate EV value are set to the drivers 18b and 18c, respectively. As a result, a brightness of a live view image is adjusted approximately.

When the flag FLG_f is updated to “1”, the CPU 26 requests a graphic generator 46 to display a person frame structure HF with reference to a registration content of the face-detection register RGSTface or the human-body-detection register RGSTbody. The graphic generator 46 outputs graphic information representing the person frame structure HF toward the LCD driver 36. The person frame structure HF is displayed on the LCD monitor 38 in a manner adapted to the position and size of any of the face image and the human-body image detected under the human-body detecting task.

Thus, when the persons HM1, HM2 and HM3 are captured by the imaging surface as shown in FIG. 8, human-body frame structures HF1 to HF3 are displayed on the LCD monitor 38 as shown in FIG. 20.

When the flag FLG_f is updated to “1”, the CPU 26 extracts, out of the 256 AE evaluation values outputted from the AE evaluating circuit 22, AE evaluation values corresponding to a position of a face image or a human-body image respectively registered in the face-detection register RGSTface or the human-body-detection register RGSTbody.

The CPU 26 executes a strict AE process that is based on the extracted partial AE evaluation values. An aperture amount and an exposure time period that define an optimal EV value calculated by the strict AE process are set to the drivers 18b and 18c, respectively. As a result, a brightness of a live view image is adjusted to a brightness in which a part of the scene equivalent to the position of the face image or the human-body image is noticed.

When the shutter button 28sh is half depressed, the CPU 26 executes a normal AF process or a person-priority AF process. When the flag FLG_f indicates “0”, the CPU 26 extracts, out of the 256 AF evaluation values outputted from the AF evaluating circuit 24, AF evaluation values corresponding to a predetermined region of a center of the scene. The CPU 26 executes a normal AF process that is based on the extracted partial AF evaluation values. As a result, the focus lens 12 is placed at a focal point in which the center of the scene is noticed, and thereby, a sharpness of a live view image is improved.

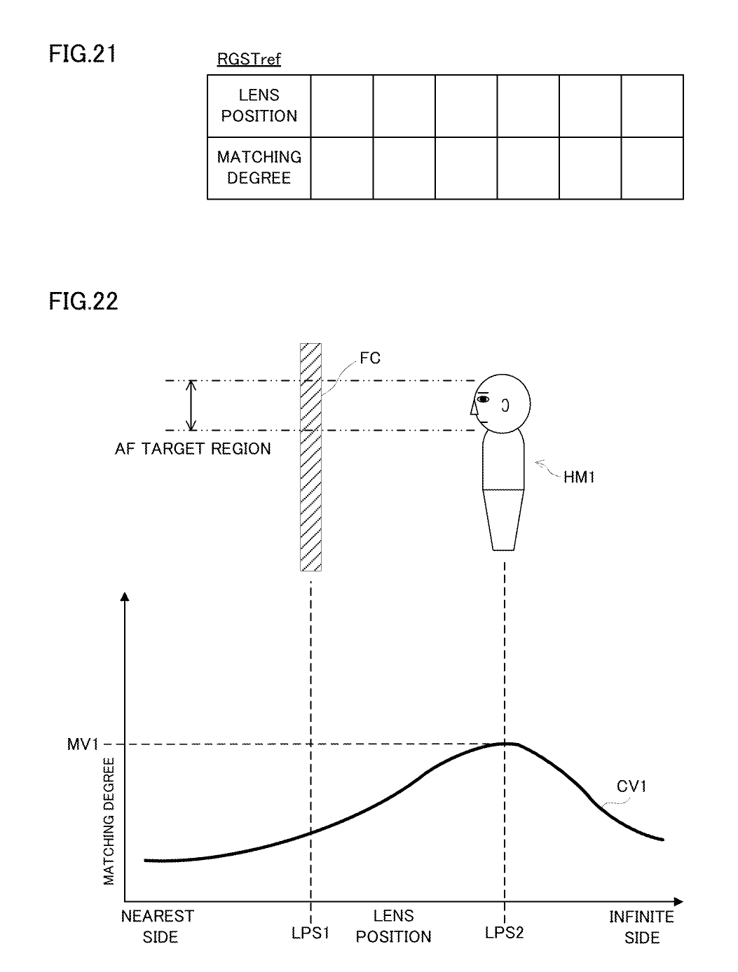

When the flag FLG_f indicates “1”, in order to finalize a target region of the AF process, the CPU 26 duplicates descriptions of the AF target register RGSTaf on a finalization register RGSTdcd. Subsequently, the CPU 26 executes the person-priority AF process so as to place the focus lens 12 at a focal point in which a person is noticed. For the person-priority AF process, a comparing register RGSTref shown in FIG. 21 is prepared.

In the person-priority AF process, firstly, the focus lens 12 is placed at an infinite-side end. At every time the vertical synchronization signal Vsync is generated, the CPU 26 commands the driver 18a to move the focus lens 12 by a predetermined width, and the driver 18a moves the focus lens 12 from the infinite-side end toward a nearest-side end by the predetermined width.

At every time the focus lens 12 is moved, partial search image data belonging within the target region of the AF process described in the finalization register RGSTdcd is read out from the search image area 32c through the memory control circuit 30. A characteristic amount of the read-out search image data is compared with a characteristic amount of a dictionary image indicated by a dictionary number described in the finalization register RGSTdcd. When the dictionary number indicates any of “1” to “5”, the dictionary images contained in the face dictionary DC_F are used for comparing, and when the dictionary number indicates “0”, the dictionary image contained in the human-body dictionary DC_B is used for comparing. A position of the focus lens 12 at a current time point and the obtained matching degree are registered in the comparing register RGSTref.

When the focus lens 12 is moved to the nearest-side end, as a result of evaluating a maximum matching degree out of matching degrees in each position of the focus lens 12 from the infinite-side end to the nearest-side end, a lens position indicating a maximum matching degree is detected as a focal point. The focal point thus discovered is set to the driver 18a, and the driver 18a places the focus lens 12 at the focal point. As a result, a sharpness of a person image included in the target region of the AF process is improved.

According to an example shown in FIG. 8, a face image of the person HM1 is used as a target region of the AF process. In this case, with reference to FIG. 22, a curve CV1 represents matching degrees in positions of the focus lens 12 from the infinite-side end to the nearest-side end.

According to the curve CV1, the matching degree is not maximum in a lens position LPS1 corresponding to a position of the fence FC. On the other hand, when a position of the focus lens 12 is in LPS2, the matching degree indicates a maximum value MV1, and therefore, the lens position LPS2 is detected as a focal point. Thus, the focus lens 12 is placed at the lens position LPS2.

When the shutter button 28sh is fully depressed after completion of the normal AF process or the person-priority AF process, the CPU 26 executes the still-image taking process and the recording process under the imaging task. One frame of image data at a time point at which the shutter button 28sh is fully depressed is taken into a still image area 32d. The taken one frame of the image data is read out from the still-image area 32d by an I/F 40 which is activated in association with the recording process, and is recorded on a recording medium 42 in a file format.

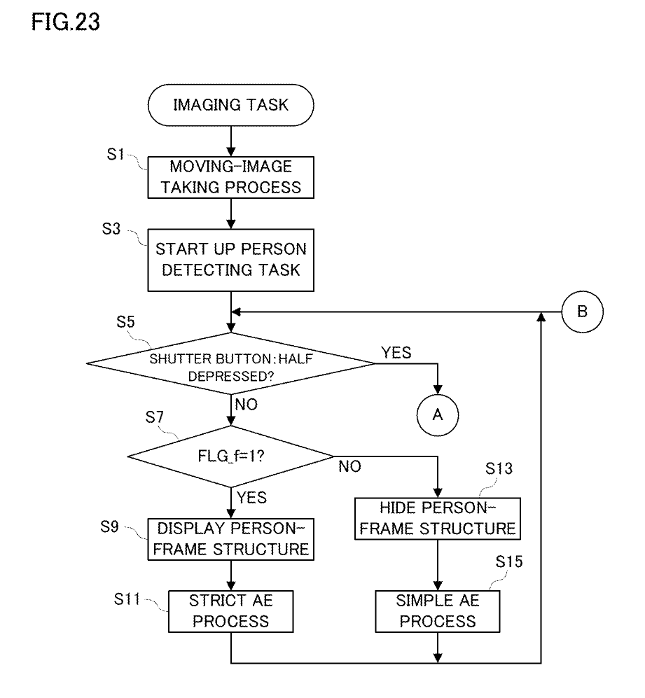

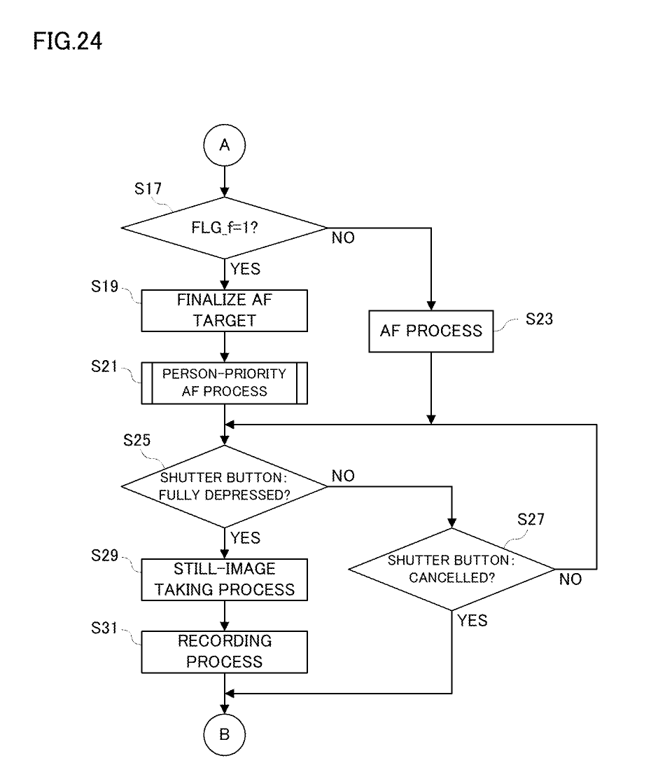

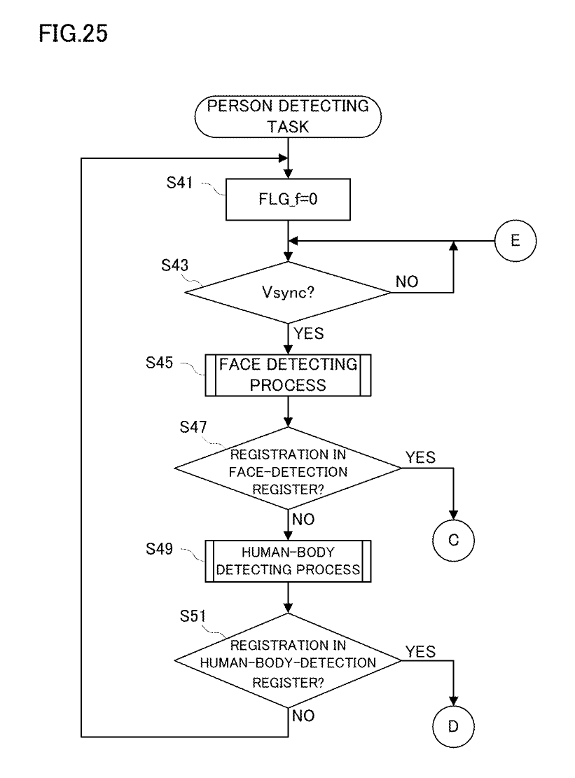

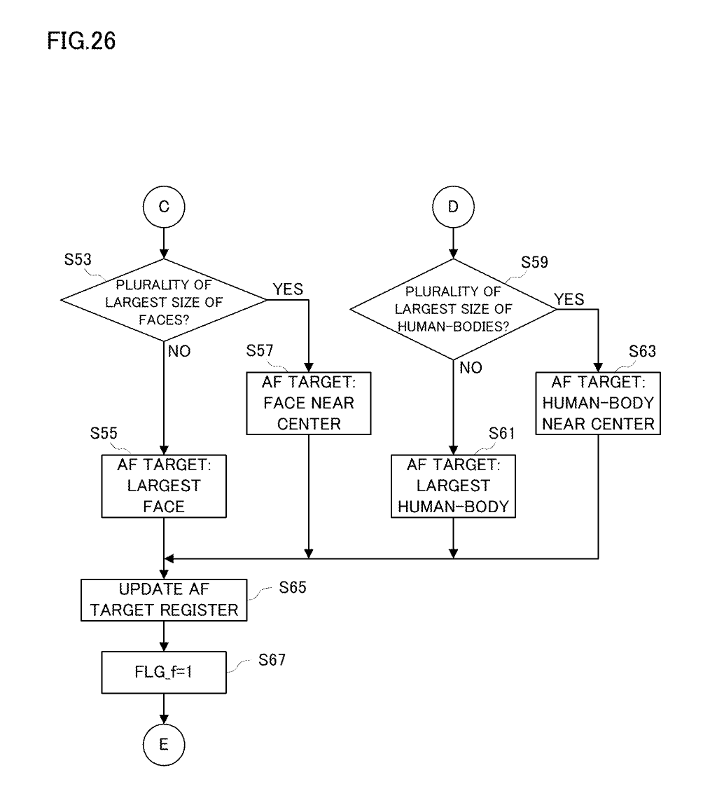

The CPU 26 executes a plurality of tasks including the imaging task shown in FIG. 23 and FIG. 24 and the person detecting task shown in FIG. 25 and FIG. 26, in a parallel manner. It is noted that, control programs corresponding to these tasks are stored in the flash memory 44.

With reference to FIG. 23, in a step S1, the moving image taking process is executed. As a result, a live view image representing a scene is displayed on the LCD monitor 38. In a step S3, the person detecting task is activated.

In a step S5, it is determined whether or not the shutter button 28sh is half depressed, and when a determined result is YES, the process advances to a step S17 whereas when the determined result is NO, in a step S7, it is determined whether or not the flag FLG_f is set to “1”. When a determined result of the step S7 is YES, in a step S9, the graphic generator 46 is requested to display a person frame structure HF with reference to a registration content of the face-detection register RGSTface or the human-body-detection register RGSTbody. As a result, the person frame structure HF is displayed on the LCD monitor 38 in a manner adapted to a position and a size of any of a face image and a human-body image detected under the human-body detecting task.

Upon completion of the process in the step S9, the strict AE process corresponding to the position of the face image or the human-body image is executed in a step S11. An aperture amount and an exposure time period that define an optimal EV value calculated by the strict AE process are set to the drivers 18b and 18c, respectively. As a result, a brightness of the live view image is adjusted to a brightness in which a part of the scene equivalent to the position of the face image or the human-body image is noticed. Upon completion of the process in the step S11, the process returns to the step S5.

When a determined result of the step S7 is NO, in a step S13, the graphic generator 46 is requested to hide the person frame structure HF. As a result, the person frame structure HF displayed on the LCD monitor 38 is hidden.

Upon completion of the process in the step S13, the simple AE process is executed in a step S15. An aperture amount and an exposure time period that define the appropriate EV value calculated by the simple AE process are set to the drivers 18b and 18c, respectively. As a result, a brightness of the live view image is adjusted approximately. Upon completion of the process in the step S15, the process returns to the step S5.

In the step S17, it is determined whether or not the flag FLG_f is set to “1”, and when a determined result is NO, the process advances to a step S23 whereas when the determined result is YES, in order to finalize a target region of the AF process, descriptions of the AF target register RGSTaf is duplicated on the finalization register RGSTdcd in a step S19.

In a step S21, the person-priority AF process is executed so as to place the focus lens 12 at a focal point in which a person is noticed. As a result, a sharpness of a person image included in the target region of the AF process is improved. Upon completion of the process in the step S21, the process advances to a step S25.

In the step S23, the normal AF process is executed. As a result, the focus lens 12 is placed at a focal point in which the center of the scene is noticed, and thereby, a sharpness of the live view image is improved. Upon completion of the process in the step S23, the process advances to the step S25.

In the step S25, it is determined whether or not the shutter button 28sh is fully depressed, and when a determined result is NO, in a step S27, it is determined whether or not the shutter button 28sh is cancelled. When a determined result of the step S27 is NO, the process returns to the step S25 whereas when the determined result of the step S27 is YES, the process returns to the step S5.

When a determined result of the step S25 is YES, the still-image taking process is executed in a step S29, and the recording process is executed in a step S31. One frame of image data at a time point at which the shutter button 28sh is fully depressed is taken into the still image area 32d by the still-image taking process. The taken one flame of the image data is read out from the still-image area 32d by an I/F 40 which is activated in association with the recording process, and is recorded on the recording medium 42 in a file format. Upon completion of the recording process, the process returns to the step S5.

With reference to FIG. 25, in a step S41, the flag FLG_f is set to “0” as an initial setting, and in a step S43, it is repeatedly determined whether or not the vertical synchronization signal Vsync has been generated. When a determined result is updated from NO to YES, the face detecting process is executed in a step S45.

Upon completion of the face detecting process, in a step S47, it is determined whether or not there is any registration of face information in the face-detection register RGSTface, and when a determined result is YES, the process advances to a step S53 whereas when the determined result is NO, the human-body detecting process is executed in a step S49.

Upon completion of the human-body detecting process, in a step S51, it is determined whether or not there is any registration of the human-body information in the human-body-detection register RGSTbody, and when a determined result is YES, the process advances to a step S59 whereas when the determined result is NO, the process returns to the step S41.

In the step S53, it is determined whether or not a plurality of face information in which a size is the largest is registered, out of the face information registered in the face-detection register RGSTface. When a determined result is NO, in a step S55, a region indicated by the face information in which the size is the largest is used as a target region of the AF process. When the determined result is YES, in a step S57, out of a plurality of maximum size of face information, a region indicated by face information in which a position is the nearest to the center of the imaging surface is used as a target region of the AF process.

In the step S59, it is determined whether or not a plurality of human-body information in which a size is the largest is registered, out of the human-body information registered in the human-body-detection register RGSTbody. When a determined result is NO, in a step S61, the human-body information in which the size is the largest is used as a target region of the AF process. When the determined result is YES, in a step S63, a region indicated by human-body information in which a position is the nearest to the center of the imaging surface out of a plurality of maximum size of human-body information is used as a target region of the AF process.

Upon completion of the process in any of the steps S55, S57, S61 and S63, in a step S65, a position and a size of the face information or the human-body information used as the target region of the AF process and a dictionary number of a comparing resource are registered in the AF target register RGSTaf. It is noted that, when the human-body information is registered, “0” is described as the dictionary number.

In a step S67, in order to declare that a person has been discovered, the flag FLG_f is set to “1”, and thereafter, the process returns to the step S43.

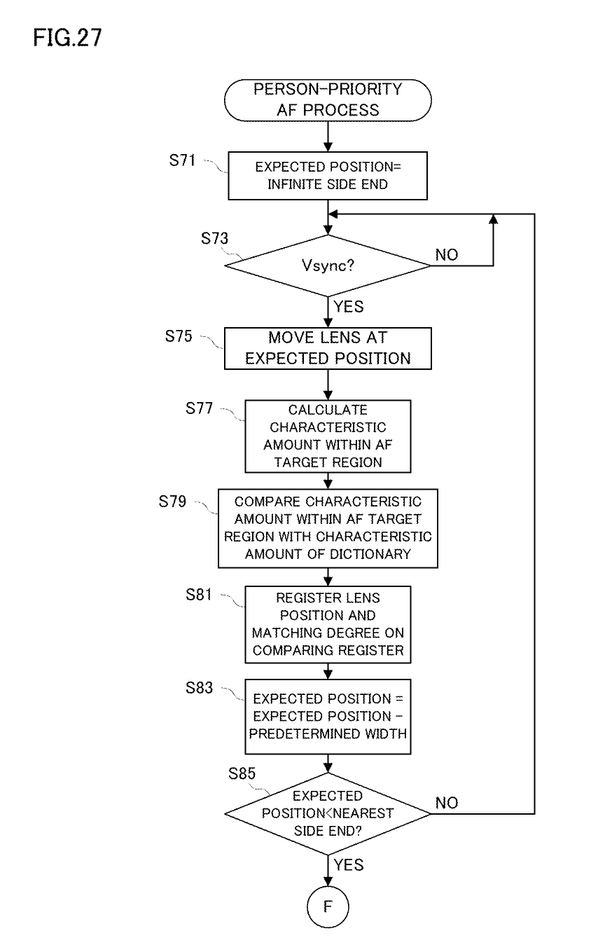

The person-priority AF process in the step S21 is executed according to a subroutine shown in FIG. 27. In a step S71, an expected position of the focus lens 12 is set to an infinite-side end, and in a step S73, it is repeatedly determined whether or not the vertical synchronization signal Vsync has been generated. When a determined result is updated from NO to YES, in a step S75, the focus lens 12 is moved to the expected position.

In a step S77, a characteristic amount of partial search image data belonging within the target region of the AF process described in the finalization register RGSTdcd is calculated, and in a step S79, the calculated characteristic amount is compared with a characteristic amount of a dictionary image indicated by a dictionary number described in the finalization register RGSTdcd. When the dictionary number indicates any of “1” to “5”, the dictionary images contained in the face dictionary DC_F are used for comparing, and when the dictionary number indicates “0”, the dictionary image contained in the human-body dictionary DC_B is used for comparing. In a step S81, a position of the focus lens 12 at a current time point and the obtained matching degree are registered in the comparing register RGSTref.

In a step S83, an expected position is set to “expected position—predetermined width”, and in a step S85, it is determined whether or not the expected position newly set is closer than a nearest-side end. When a determined result is NO, the process returns to the step S73 whereas when the determined result is YES, the process advances to a step S87.

In the step S87, an expected position is set to a lens position indicating a maximum matching degree out of matching degrees registered in the comparing register RGSTref, and in a step S89, the focus lens 12 is moved to the expected position. Upon completion of the process in the step S89, the process returns to the routine in an upper hierarchy.

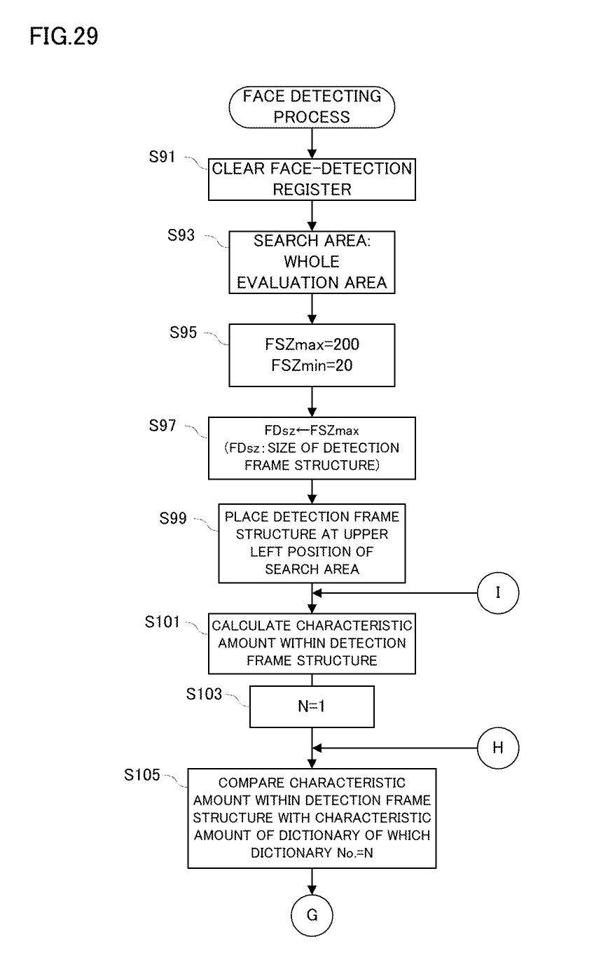

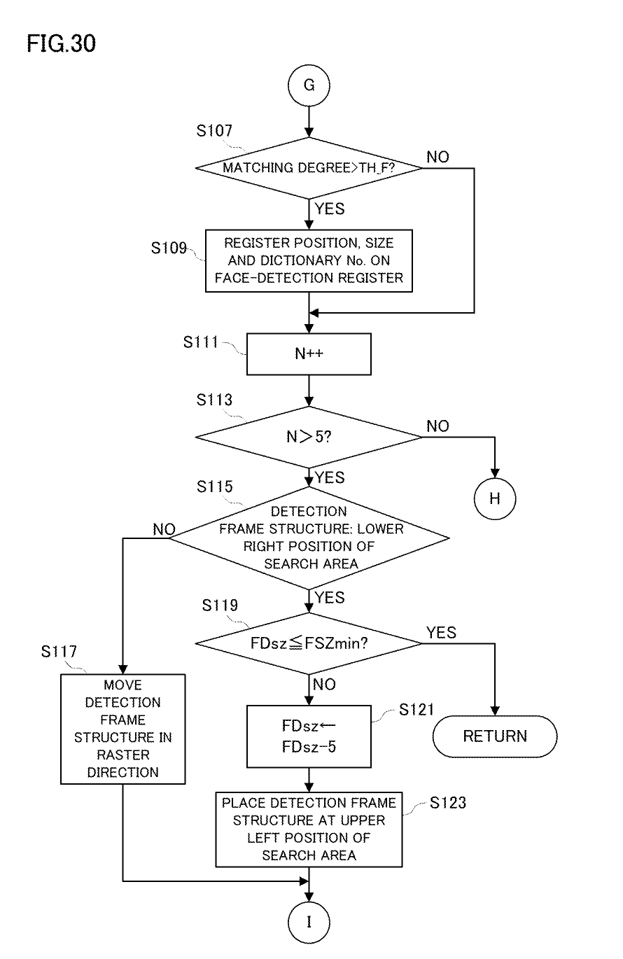

The face detecting process in the step S45 is executed according to a subroutine shown in FIG. 29 to FIG. 30. In a step S91, the registration content is cleared in order to initialize the face-detection register RGSTface.

In a step S93, the whole evaluation area EVA is set as a search area. In a step S95, in order to define a variable range of a size of the face-detection frame structure FD, a maximum size FSZmax is set to “200”, and a minimum size FSZmin is set to “20”.

In a step S97, the size of the face-detection frame structure FD is set to “FSZmax”, and in a step S99, the face-detection frame structure FD is placed at an upper left position of the search area. In a step S101, partial search image data belonging to the face-detection frame structure FD is read out from the search image area 32c so as to calculate a characteristic amount of the read-out search image data.

In a step S103, a variable N is set to “1”, and in a step S105, the characteristic amount calculated in the step S101 is compared with a characteristic amount of a dictionary image in the face dictionary DC_F in which a dictionary number is N. In a step S107, it is determined whether or not a matching degree equal to or more than a threshold value TH_F is obtained, and when a determined result is NO, the process advances to a step S111 whereas when the determined result is YES, the process advances to the step S111 via a process in a step S109.

In the step S109, a position and a size of the face-detection frame structure FD and a dictionary number of a comparing resource at a current time point are registered as face information in the face-detection register RGSTface.

In the step S111, the variable N is incremented, and in a step S113, it is determined whether or not the variable N exceeds “5”. When a determined result is NO, the process returns to the step S105 whereas when the determined result is YES, in a step S115, it is determined whether or not the face-detection frame structure FD has reached a lower right position of the search area.

When a determined result of the step S115 is NO, in a step S117, the face-detection frame structure FD is moved in a raster direction by a predetermined amount, and thereafter, the process returns to the step S101. When the determined result of the step S115 is YES, in a step S119, it is determined whether or not the size of the face-detection frame structure FD is equal to or less than “FSZmin”. When a determined result of the step S119 is NO, in a step S121, the size of the face-detection frame structure FD is reduced by a scale of “5”, in a step S123, the face-detection frame structure FD is placed at the upper left position of the search area, and thereafter, the process returns to the step S101. When the determined result of the step S119 is YES, the process returns to the routine in an upper hierarchy.

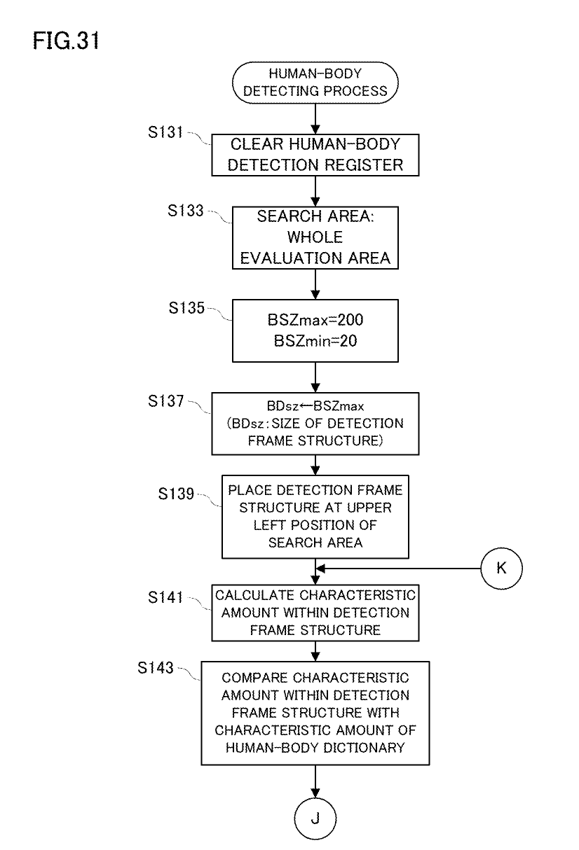

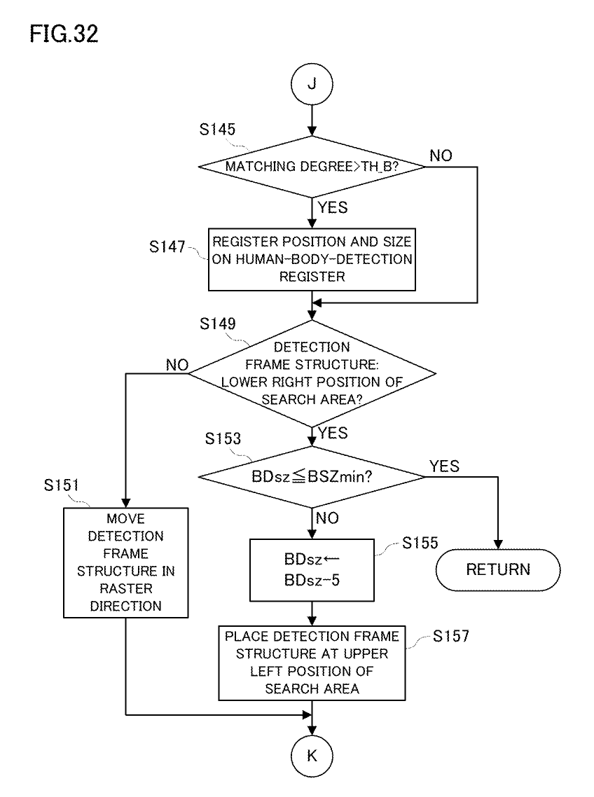

The human-body detecting process in the step S49 is executed according to a subroutine shown in FIG. 31 to FIG. 32. In a step S131, the registration content is cleared in order to initialize the human-body-detection register RGSTbody.

In a step S133, the whole evaluation area EVA is set as a search area. In a step S135, in order to define a variable range of a size of the human-body-detection frame structure BD, a maximum size BSZmax is set to “200”, and a minimum size BSZmin is set to “20”.

In a step S137, the size of the human-body-detection frame structure BD is set to “BSZmax”, and in a step S139, the human-body-detection frame structure BD is placed at the upper left position of the search area. In a step S141, partial search image data belonging to the human-body-detection frame structure BD is read out from the search image area 32c so as to calculate a characteristic amount of the read-out search image data.

In a step S143, the characteristic amount calculated in the step S141 is compared with a characteristic amount of a dictionary image in the human-body dictionary DC_B. In a step S145, it is determined whether or not a matching degree equal to or more than a threshold value TH_B is obtained, and when a determined result is NO, the process advances to a step S149 whereas when the determined result is YES, the process advances to the step S149 via a process in a step S147. In the step S147, a position and a size of the human-body-detection frame structure BD at a current time point are registered as human-body information in the human-body-detection register RGSTbody.

In the step S149, it is determined whether or not the human-body-detection frame structure BD has reached a lower right position of the search area, and when a determined result is NO, in a step S151, the human-body-detection frame structure BD is moved in a raster direction by a predetermined amount, and thereafter, the process returns to the step S141. When the determined result is YES, in a step S153, it is determined whether or not the size of the human-body-detection frame structure BD is equal to or less than “BSZmin”. When a determined result of the step S153 is NO, in a step S155, the size of the human-body-detection frame structure BD is reduced by a scale of “5”, in a step S157, the human-body-detection frame structure BD is placed at the upper left position of the search area, and thereafter, the process returns to the step S141. When the determined result of the step S153 is YES, the process returns to the routine in an upper hierarchy.

As can be seen from the above-described explanation, the CPU 26 has an imaging surface capturing a scene through the focus lens 12, repeatedly outputs a scene image, and designates, on the imaging surface, an area corresponding to a partial image coincident with a dictionary image out of the scene image outputted from the image sensor 16. The CPU 26 and the driver 18a repeatedly changes a distance from the focus lens 12 to the imaging surface after the designating process. The CPU 26 calculates a matching degree between a partial image outputted from the image sensor 16 corresponding to the area designated by the designating process and the dictionary image, corresponding to each of a plurality of distances defined by the changing process. Moreover, the CPU 26 adjusts the distance from the focus lens 12 to the imaging surface based on a calculated result of the calculating process.

The distance from the focus lens 12 to the imaging surface is repeatedly changed after the area corresponding to the partial image coincident with the dictionary image is designated on the imaging surface. The matching degree between the partial image corresponding to the designated area and the dictionary image is calculated corresponding to each of the plurality of distances defined by the changing process. The calculated matching degree is regarded as a focus degree corresponding to an object equivalent to the partial image, and the distance from the focus lens to the imaging surface is adjusted based on the matching degree. Thereby, a focus performance is improved.

It is noted that, in this embodiment, in the person-priority AF process, as a result of evaluating a maximum matching degree out of matching degrees in positions of the focus lens 12 from the infinite-side end to the nearest-side end, a lens position indicating a maximum matching degree is detected as a focal point. However, an AF evaluation value of a target region of the AF process may be measured in each lens position in which a matching degree exceeds a threshold value so as to use a lens position in which the measured AF evaluation value indicates a maximum value as the focal point.

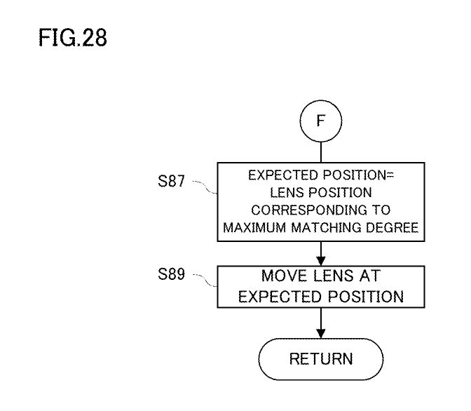

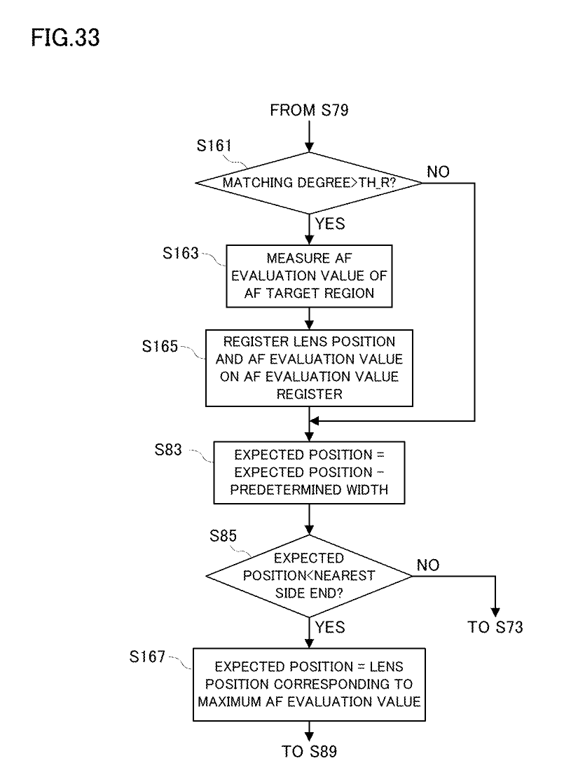

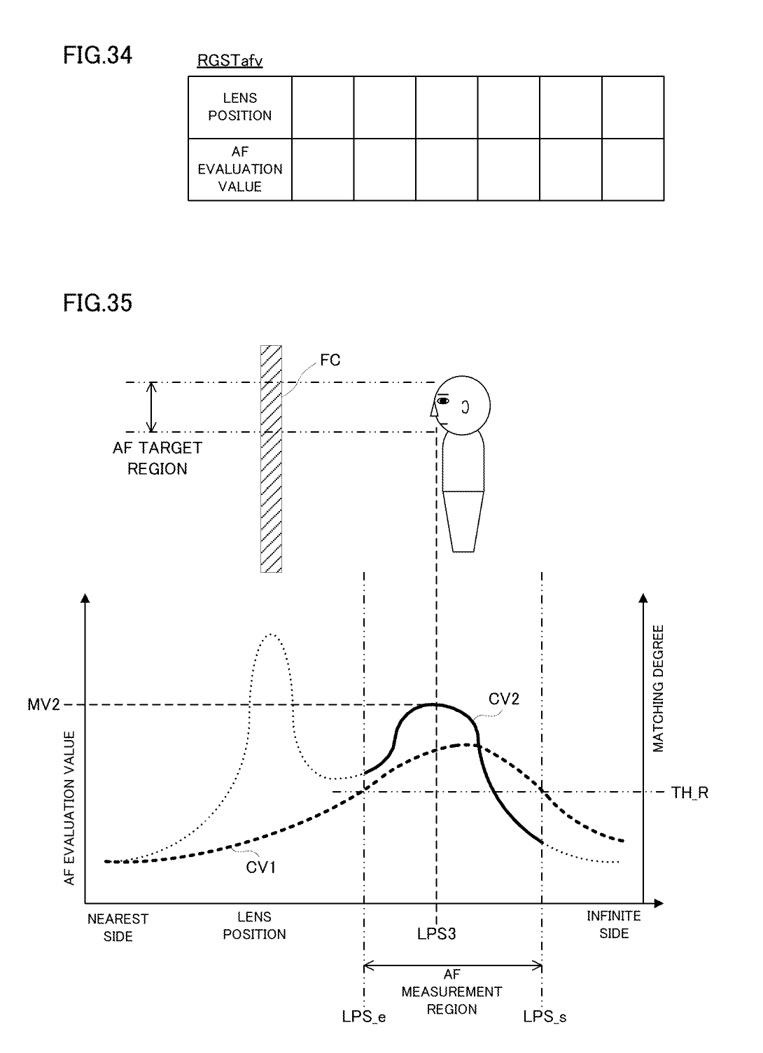

In this case, steps S161 to S165 shown in FIG. 33 may be executed instead of the step S81 shown in FIG. 27, and a step S167 shown in FIG. 33 may be executed instead of the step S87 shown in FIG. 28. Moreover, for the person priority AF process, an AF evaluation value register RGSTafv shown in FIG. 34 is prepared.

In the step S161, it is determined whether or not the matching degree obtained by the process in the step S79 exceeds a threshold value TH_R, and when a determined result is NO, the process advances to the step S83 whereas when the determined result is YES, the process advances to the step S83 via processes in the step S163 and S165.

In the step S163, an AF evaluation value within the target region of the AF process described in the finalization register RGSTdcd is measured. Measuring is performed by evaluating an average value of the AF evaluation values within the target region of the AF process out of the 256 AF evaluation values outputted from the AF evaluating circuit 24. In the step S165, a position of the focus lens 12 at a current time point and the measured AF evaluation value is registered in the AF evaluation value register RGSTafv.

In the step S167, an expected position is set to a lens position indicating a maximum value out of the AF evaluation values registered in the AF evaluation value register RGSTafv. Upon completion of the process in the step S167, the process advances to the step S89.

With reference to FIG. 35, similarly to FIG. 22, the curve CV1 represents matching degrees in positions of the focus lens 12 from the infinite-side end to the nearest-side end. A solid line portion of a curve CV2 represents an AF evaluation value of a target region of the AF process in each lens position in which a matching degree exceeds the threshold value TH_R. Moreover, a dot line portion of the curve CV2 represents an AF evaluation value of a target region of the AF process in each lens position in which a matching degree is equal to or less than the threshold value TH_R.

According the curve CV2, the matching degree exceeds the threshold value TH_R within a range in which a lens position exists from LPS_s to LPS_e. Therefore, in the lens position within the range, an AF evaluation value within the target region of the AF process described in the finalization register RGSTdcd is measured.

According to the curve CV1, in a lens position corresponding to the position of the fence FC, a matching degree does not exceed the threshold value TH_R, and therefore, the AF evaluation value within the target region of the AF process is not measured. On the other hand, according to the solid line portion of the curve CV2, when a position of the focus lens 12 is at LPS3, the AF evaluation value within the target region of the AF process indicates a maximum value MV2, and therefore, the lens position LPS3 is detected as a focal point. Therefore, the focus lens 12 is placed at the lens position LPS3.

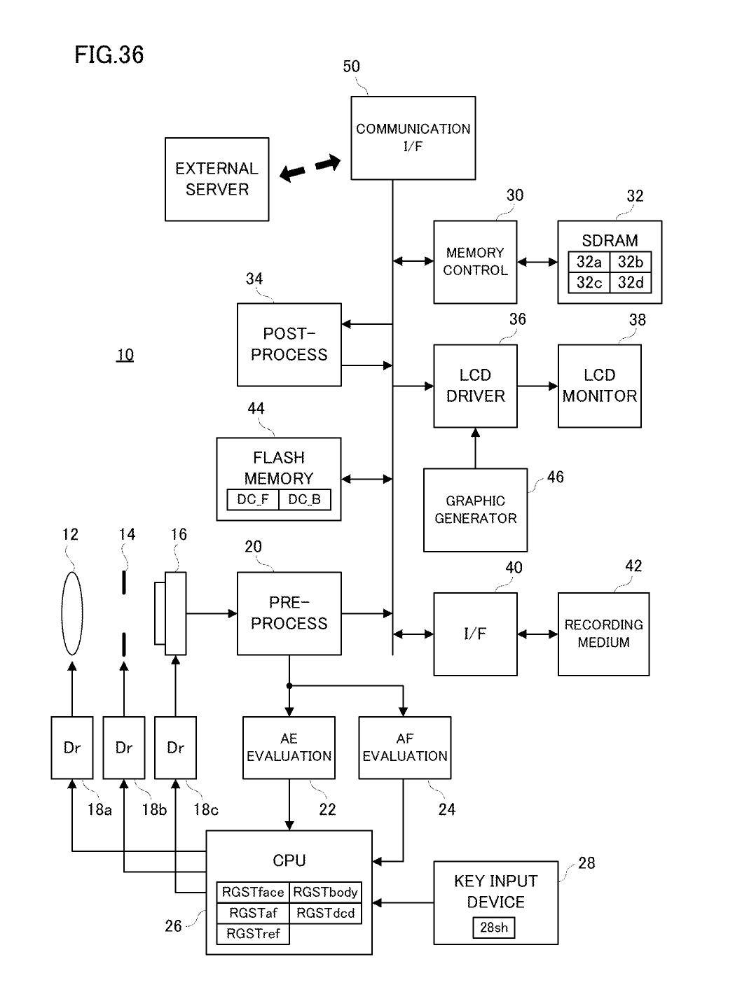

Moreover, in this embodiment, the control programs equivalent to the multi task operating system and the plurality of tasks executed thereby are previously stored in the flash memory 44. However, a communication I/F 50 may be arranged in the digital camera 10 as shown in FIG. 36 so as to initially prepare a part of the control programs in the flash memory 44 as an internal control program whereas acquire another part of the control programs from an external server as an external control program. In this case, the above-described procedures are realized in cooperation with the internal control program and the external control program.

Moreover, in this embodiment, the processes executed by the CPU 26 are divided into a plurality of tasks including the imaging task shown in FIG. 23 to FIG. 24 and the person detecting task shown in FIG. 25 to FIG. 26. However, these tasks may be further divided into a plurality of small tasks, and furthermore, a part of the divided plurality of small tasks may be integrated into the main task. Moreover, when a transferring task is divided into the plurality of small tasks, the whole task or a part of the task may be acquired from the external server.

Moreover, in this embodiment, the present invention is explained by using a digital still camera, however, a digital video camera, cell phone units and a smartphone may be applied to.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera, comprising:
an imager, having an imaging surface capturing an optical image through a focus lens, which repeatedly outputs an electronic image corresponding to the optical image;
a designator which designates, on said imaging surface, an area corresponding to a partial image coincident with a dictionary image out of the electronic image outputted from said imager;
a changer which repeatedly changes a distance from said focus lens to said imaging surface after a designating process of said designator;
a calculator which calculates a matching degree between a partial image outputted from said imager corresponding to the area designated by said designator and the dictionary image, corresponding to each of a plurality of distances defined by said changer; and
an adjuster which adjusts the distance from said focus lens to said imaging surface based on a calculated result of said calculator.

2. An electronic camera according to claim 1, wherein said adjuster includes a distance specifier which specifies a distance of which the matching degree calculated by said calculator indicates a maximum value, from among the plurality of distances defined by said changer, and a distance setter which sets the distance from said focus lens to said imaging surface to the distance specified by said distance specifier.

3. An electronic camera according to claim 1, further comprising:
a detector which detects one or at least two distances of which the matching degree calculated by said calculator indicates equal to or more than a predetermined value, from among the plurality of distances defined by said changer; and
a measurer which measures a focus degree of the area designated by said designator corresponding to each of the one or at least two distances detected by said detector, wherein the distance adjusted by said adjuster is a distance corresponding to a maximum focus degree out of one or at least two focus degrees measured by said measurer.

4. An electronic camera according to claim 1, wherein said designator includes a partial image detector which detects one or at least two partial images coincident with a dictionary image out of the electronic image outputted from said imager, and an area extractor which extracts an area corresponding to a maximum size of partial image out of the one or at least two partial images detected by said partial image detector.

5. An electronic camera according to claim 1, wherein the dictionary image used by said designator is equivalent to a person image.

6. A computer program embodied in a tangible medium, which is executed by a processor of an electronic camera, said program comprising:
an imaging step, having an imaging surface capturing an optical image through a focus lens, of repeatedly outputting an electronic image corresponding to the optical image;
a designating step of designating, on said imaging surface, an area corresponding to a partial image coincident with a dictionary image out of the electronic image outputted from said imaging step;
a changing step of repeatedly changing a distance from said focus lens to said imaging surface after a designating process of said designating step;
a calculating step of calculating a matching degree between a partial image outputted from said imaging step corresponding to the area designated by said designating step and the dictionary image, corresponding to each of a plurality of distances defined by said changing step; and
an adjusting step of adjusting the distance from said focus lens to said imaging surface based on a calculated result of said calculating step.

7. An imaging control method executed by an electronic camera, comprising:
an imaging step, having an imaging surface capturing an optical image through a focus lens, of repeatedly outputting an electronic image corresponding to the optical image;
a designating step of designating, on said imaging surface, an area corresponding to a partial image coincident with a dictionary image out of the electronic image outputted from said imaging step;
a changing step of repeatedly changing a distance from said focus lens to said imaging surface after a designating process of said designating step;
a calculating step of calculating a matching degree between a partial image outputted from said imaging step corresponding to the area designated by said designating step and the dictionary image, corresponding to each of a plurality of distances defined by said changing step; and
an adjusting step of adjusting the distance from said focus lens to said imaging surface based on a calculated result of said calculating step.
